(19) United States
(12) Patent Application Publication
(10) Pub. No.: US 2026/0120635 A1
(43) Pub. Date: Apr. 30, 2026

(54) SUBPIXEL AND DISPLAY DEVICE

(71) Applicant: LG Display Co., Ltd., Seoul (KR)

(72) Inventors: Hyunsuk CHO, Paju-si (KR); SangHyuck BAE, Paju-si (KR); Sungsu HAN, Paju-si (KR); JuHong KIM, Paju-si (KR)

(73) Assignee: LG Display Co., Ltd., Seoul (KR)

(21) Appl. No.: 19/296,060

(22) Filed: Aug. 11, 2025

(30) Foreign Application Priority Data
Oct. 31, 2024 (KR) 10-2024-0152890

(51) Int. Cl. G09G 3/3233

(52) U.S. Cl. CPC G09G 3/3233; G09G 2300/0842; G09G 2300/0861; G09G 2310/08; G09G 2320/0233; G09G 2320/045; G09G 2330/021; G09G 2354/00

(57) ABSTRACT

Embodiments of the disclosure may provide a subpixel and a display device. The subpixel comprises a light emitting element including a pixel electrode, a light emitting layer, and a common electrode, a first driving transistor controlling connection between the first driving voltage line and the pixel electrode according to a first gate voltage, and a second driving transistor controlling connection between the second driving voltage line and the pixel electrode according to a second gate voltage different from the first gate voltage, thereby providing a subpixel including two driving transistors that may be alternately driven in one subpixel.

### CROSS-REFERENCE TO RELATED APPLICATION

This application claims priority from Korean Patent Application No. 10-2024-0152890, filed on Oct. 31, 2024, which is hereby incorporated by reference for all purposes as if fully set forth herein.

### BACKGROUND

### Technical Field

Embodiments of the disclosure relate to a subpixel and a display device.

### Description of the Related Art

Recently, organic light emitting display devices, which have been in the spotlight as display devices, have the advantages of fast response speed, high luminous efficiency, brightness, and viewing angle by adopting self-emissive organic light emitting diodes (OLEDs).

The driving transistor in each subpixel of the organic light emitting display device is degraded as the driving time increases, and characteristic values such as threshold voltage and mobility may change.

Further, organic light emitting diodes may also deteriorate as the driving time increases, resulting in changes in characteristics such as threshold voltages, and variations in characteristics between organic light emitting diodes in the subpixels because the degree of deterioration between organic light emitting diodes may vary.

### BRIEF SUMMARY

The disclosure provides a method for compensating for characteristic values between driving transistors and compensating for characteristic values due to deterioration of the organic light emitting diode.

Conventional devices using organic light emitting diodes require a separate time for compensating for characteristic values due to deterioration of the organic light emitting diode or the driving transistor. Embodiments of the disclosure may provide a subpixel and a display device capable of compensating for the characteristic value of the organic light emitting diode or the driving transistor during driving of the organic light emitting diode.

Embodiments of the disclosure may provide a subpixel and a display device including two driving transistors capable of alternately driving within one subpixel.

Embodiments of the disclosure may provide a subpixel and a display device including a plurality of emission control transistors that control connection of nodes according to a single emission control signal.

Embodiments of the disclosure may provide a subpixel and a display device including two driving transistors connected between one pixel electrode and two driving voltage lines.

Embodiments of the disclosure may provide a display panel comprising a plurality of subpixels, a plurality of data lines, and a plurality of reference voltage lines, wherein each of the plurality of subpixels includes a light emitting element including a pixel electrode, an intermediate layer, and a common electrode, a first driving transistor controlling connection between a second node and a third node according to a voltage applied to a first node to drive the light emitting element, a first scan transistor controlling connection between a first data line among the plurality of data lines and the first node according to a first scan signal, a first sensing transistor controlling connection between a first reference voltage line among the plurality of reference voltage lines and the second node according to a first sensing signal, a first emission control transistor controlling connection between the first node and a fourth node according to a first emission control signal, a second emission control transistor controlling connection between the second node and a fifth node according to the first emission control signal, and a storage capacitor electrically connected between the fourth node and the fifth node, and wherein a first gate node of the first emission control transistor and a second gate node of the second emission control transistor are connected.

Embodiments of the disclosure may provide a display device comprising a first subpixel, a first data line connected to the first subpixel, a second data line connected to the first subpixel, a first reference voltage line connected to the first subpixel, a second reference voltage line connected to the first subpixel, a data link line to which a data voltage is applied, a sensing driving link line to which a sensing driving voltage is applied, and a first selection circuit electrically connecting one of the data link line and the sensing driving link line with one of the first data line and the second data line.

Embodiments of the disclosure may provide a subpixel comprising a light emitting element including a pixel electrode, a light emitting layer, and a common electrode, a first driving transistor controlling connection between the first driving voltage line and the pixel electrode according to a first gate voltage, and a second driving transistor controlling connection between the second driving voltage line and the pixel electrode according to a second gate voltage different from the first gate voltage.

According to embodiments of the disclosure, there may be provided a subpixel and a display device that provide a first emission control transistor and a second emission control transistor that control connection of nodes according to a first emission control signal.

According to embodiments of the disclosure, there may be provided a subpixel and a display device that provide a third emission control transistor and a fourth emission control transistor that control the connection of nodes according to a second emission control signal.

According to embodiments of the disclosure, there may be provided a subpixel and a display device that simultaneously sense light emission of the light emitting element and the characteristic value of the driving transistor as the first driving transistor and the second driving transistor may be alternately driven.

According to embodiments of the disclosure, there may be provided a display device including a selection circuit for selecting data lines for light emission of the light emitting element and sensing a characteristic value of the driving transistor.

According to embodiments of the disclosure, it is possible to enhance the efficiency, mobility, and lifespan of the driving transistor and drive the subpixel with low power by compensating for the characteristic value of the driving transistor during driving of the subpixel.

### BRIEF DESCRIPTION OF THE SEVERAL VIEWS OF THE DRAWINGS

The above and other objects, features, and advantages of the disclosure will be more clearly understood from the following detailed description, taken in conjunction with the accompanying drawings, in which:

FIG. 1 is a view illustrating a system configuration of a display device according to embodiments of the disclosure;

FIG. 2 illustrates a first selection circuit and a second selection circuit of a display device according to embodiments of the disclosure;

FIG. 3 illustrates a subpixel of a display device according to embodiments of the disclosure;

FIG. 4 is illustrates a timing diagram for driving a subpixel SP of a display device according to embodiments of the disclosure;

FIG. 5 illustrates a third driving period of a first driving period in a method for driving a subpixel of a display device according to embodiments of the disclosure;

FIG. 6 illustrates a fourth driving period of a first driving period in a method for driving a subpixel of a display device according to embodiments of the disclosure;

FIG. 7 illustrates a fifth driving period of a second driving period in a method for driving a subpixel of a display device according to embodiments of the disclosure; and

FIG. 8 illustrates a sixth driving period of a second driving period in a method for driving a subpixel of a display device according to embodiments of the disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may”fully encompasses all the meanings of the term “can”.

Hereinafter, various embodiments of the disclosure are described in detail with reference to the accompanying drawings.

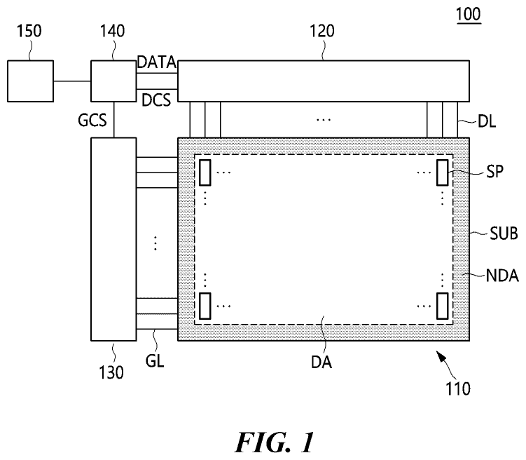

FIG. 1 is a view illustrating a system configuration of a display device 100 according to embodiments of the disclosure.

Referring to FIG. 1, a display device 100 according to embodiments of the disclosure may include a display panel 110 and display driving circuits, as components for displaying images. The display driving circuit may be a circuit for driving the display panel 110. The display driving circuits may include a data driving circuit 120, a gate driving circuit 130, and a controller 140, but embodiments of the disclosure are not limited thereto.

The display panel 110 may include a substrate SUB and a plurality of subpixels SP disposed on the substrate SUB.

The substrate SUB may include a display area DA and a non-display area NDA.

The display area DA is an area where images may be displayed, and may also be referred to as an active area. A plurality of subpixels SP for image display may be disposed in the display area DA.

The non-display area NDA is an area where no image is displayed and may be an area outside the display area DA. The non-display area NDA may also be referred to as a bezel (or bezel area). The non-display area NDA may include a pad area.

For example, the non-display area NDA may include a first non-display area, a second non-display area, a third non-display area, and a fourth non-display area. The first non-display area may be positioned outside the display area DA in the row direction. The second non-display area may be positioned outside the display area DA in the row direction and may be positioned opposite to the first non-display area. The third non-display area may be positioned outside the display area DA in the column direction. The fourth non-display area may be positioned outside the display area DA in the column direction and may be positioned opposite to the third non-display area.

Among the first to fourth non-display areas, the fourth non-display area may include a pad area where a driving circuit is connected, bonded (or attached), and the first to third non-display areas may have a very small size, but the embodiments of the disclosure are not limited thereto.

As another example, the boundary area between the display area DA and the non-display area NDA may be bent so that the non-display area NDA may be positioned under the display area.

No or little change may be made to the non-display area NDA shown to the user when the user views the display area DA from the front, but embodiments of the disclosure are not limited thereto.

The display device 100 according to embodiments of the disclosure may be a self-emission display device in which the display panel 110 emits light by itself, but embodiments of the disclosure are not limited thereto. When the display device 100 according to the embodiments of the disclosure is a self-emission display device, each of the plurality of subpixels SP may include a light emitting element.

For example, the display device 100 according to embodiments of the disclosure may be an organic light emitting diode display in which the light emitting element is implemented as an organic light emitting diode (OLED). As another example, the display device 100 according to embodiments of the disclosure may be an inorganic light emitting display device in which the light emitting element is implemented as an inorganic material-based light emitting diode. As another example, the display device 100 according to embodiments of the disclosure may be a quantum dot display device in which the light emitting element is implemented as a quantum dot which is self-emission semiconductor crystal. As another example, the display device 100 according to embodiments of the disclosure may be a micro LED display device or a mini LED display device.

The structure of each of the plurality of subpixels SP may vary according to the type of the display device 100. For example, when the display device 100 is a self-emission display device in which the subpixels SP emit light by themselves, each subpixel SP may include a light emitting element that emits light by itself, one or more transistors, and one or more capacitors, but embodiments of the disclosure are not limited thereto.

Various types of signal lines for driving a plurality of subpixels SP may be disposed on the substrate SUB of the display panel 110. For example, various types of signal lines may include a plurality of data lines DL transferring data signals (also referred to as data voltages or image signals) and a plurality of gate lines GL transferring gate signals (also referred to as scan signals).

The plurality of data lines DL and the plurality of gate lines GL may cross each other. Each of the plurality of data lines DL may be disposed to extend in the column direction. Each of the plurality of gate lines GL may be disposed to extend in the row direction. According to embodiments of the disclosure, the column direction and the row direction may be relative directions. For example, the column direction may be the row direction depending on the viewpoint, and the row direction may be the column direction depending on the viewpoint. For convenience of description, described below is an example in which each of the plurality of data lines DL is disposed in the column direction, and each of the plurality of gate lines GL is disposed in the row direction, but embodiments of the disclosure are not limited thereto. In embodiments of the disclosure, the angle between the row direction and the column direction may be 90 degrees or may an angle different from 90 degrees. Further, in embodiments of the disclosure, the row direction may be referred to as a first direction, and the column direction may be referred to as a second direction.

The data driving circuit 120 may be a circuit for driving the plurality of data lines DL, and may out data signals to the plurality of data lines DL.

The data driving circuit 120 may receive digital image data DATA from the controller 140 and may convert the received image data DATA into analog data signals (or also referred to as data voltages) and output them to the plurality of data lines DL.

For example, the data driving circuit 120 may be connected with the display panel 110 by a tape automated bonding (TAB) method or connected to a bonding pad of the display panel 110 by a chip on glass (COG) or chip on panel (COP) method or may be implemented by a chip on film (COF) method and connected with the display panel 110, but embodiments of the disclosure are not limited thereto.

The data driving circuit 120 may be connected to one side (e.g., an upper or lower side) of the display panel 110. As another example, depending on the driving scheme or the panel design scheme, data driving circuits 120 may be connected with both the sides (e.g., both the upper and lower sides) of the display panel 110, or two or more of the four sides of the display panel 110.

The data driving circuit 120 may be disposed outside the display area DA of the display panel 110, but as another example, the data driving circuit 120 may be disposed in the display area DA of the display panel 110.

The gate driving circuit 130 is a circuit for driving the plurality of gate lines GL, and may output gate signals to the plurality of gate lines GL.

The gate driving circuit 130 may receive a first gate voltage corresponding to a turn-on voltage (or also referred to as a turn-on level voltage) and a second gate voltage corresponding to a turn-off voltage (or also referred to as a turn-off level voltage) together with various gate driving control signals GCS, generate gate signals including a section having the first gate voltage and a section having the second gate voltage for a predetermined time (e.g., one frame time), and supply the generated gate signals to the plurality of gate lines GL. For example, the turn-on level voltage may be a high level voltage, and the turn-off level voltage may be a low level voltage. As another example, the turn-on level voltage may be a low level voltage, and the turn-off level voltage may be a high level voltage.

In the display device 100 according to embodiments of the disclosure, the gate driving circuit 130 may be embedded, in a gate in panel (GIP) type, in the display panel 110, but embodiments of the disclosure are not limited thereto. When the gate driving circuit 130 is of the gate in panel type, the gate driving circuit 130 may be formed on the substrate SUB of the display panel 110 during the manufacturing process of the display panel 110.

For example, the gate driving circuit 130 may be disposed in the non-active area NDA of the display panel 110.

As another example, the gate driving circuit 130 may be disposed in the display area DA of the display panel 110. For example, the gate driving circuit 130 may be disposed in a first partial area in the display area DA (e.g., a left area or a right area in the display area DA). As another example, the gate driving circuit 130 may be disposed in a first partial area in the display area DA (e.g., a left area or right area in the display area DA) and a second partial area (e.g., a right area or left area in the display area DA). As another example, the gate driving circuit 130 may be disposed over the entire display area DA.

When the gate driving circuit 130 is disposed in the display area DA of the display panel 110, the gate driving circuit 130 may vertically overlap the subpixels SP disposed in the display area DA. For example, the gate driving circuit 130 may vertically overlap the light emitting elements and transistors included in the disposed subpixels SP in the display area DA. The gate driving circuit 130 may vertically overlap a plurality of light emitting elements and a plurality of transistors included in a plurality of subpixels SP disposed in the display area DA. The gate driving circuit 130 may include a plurality of transistors. Each of the plurality of transistors included in the gate driving circuit 130 may include an active layer including a first semiconductor material, and each of the plurality of transistors included in the subpixels SP may include an active layer including a second semiconductor material. For example, the first semiconductor material and the second semiconductor material may be substantially identical. As another example, the first semiconductor material and the second semiconductor material may be different from each other. For example, the first semiconductor material may be a silicon-based semiconductor material (e.g., low temperature poly silicon), and the second semiconductor material may be an oxide semiconductor material. For example, the active layer may be, but is not limited to, a semiconductor layer.

The controller 140 is a device for controlling the data driving circuit 120 and the gate driving circuit 130 and may control driving timings for the plurality of data lines DL and driving timings for the plurality of gate lines GL.

The controller 140 may supply a data driving control signal DCS to the data driving circuit 120 to control the data driving circuit 120 and may supply a gate driving control signal GCS to the gate driving circuit 130 to control the gate driving circuit 130.

The controller 140 may receive input image data from the host system 150 and supply image data DATA to the data driving circuit 120 based on the input image data.

The controller 140 may be implemented as a separate component from the data driving circuit 120, or the controller 140 and the data driving circuit 120 may be integrated into an integrated circuit (IC).

The controller 140 may be a timing controller used in display technology, a control device that may perform other control functions as well as the functions of the timing controller, or a control device other than the timing controller, or may be a circuit in the control device. The controller 140 may be implemented as various circuits or electronic components, such as an integrated circuit (IC), a field programmable gate array (FPGA), an application specific integrated circuit (ASIC), or a processor, but is not limited thereto.

The controller 140 may be mounted on a printed circuit board or a flexible printed circuit and may be electrically connected with the data driving circuit 120 and the gate driving circuit 130 through the printed circuit board or the flexible printed circuit.

The controller 140 may transmit/receive signals to/from the data driving circuit 120 according to one or more predetermined interfaces. The interface may include, e.g., a low voltage differential signaling (LVDS) interface, an embedded clock point-point interface (EPI), and a serial peripheral interface (SPI), but embodiments of the disclosure are not limited thereto.

To provide a touch sensing function as well as an image display function, the display device 100 according to embodiments of the disclosure may include a touch sensor and a touch sensing circuit that senses the touch sensor to detect whether a touch occurs by a touch object, such as a finger or pen, or the position of the touch.

The touch sensing circuit may include a touch driving circuit that drives and senses the touch sensor and generates and outputs touch sensing data and a touch controller that may detect an occurrence of a touch or the position of the touch using touch sensing data.

The touch sensor may include a plurality of touch electrodes. The touch sensor may further include a plurality of touch lines for electrically connecting the plurality of touch electrodes and the touch driving circuit.

The touch sensor may be present in a touch panel form outside the display panel 110 or may be present inside the display panel 110. When the touch panel, in the form of a touch panel, exists outside the display panel 110, the touch panel is of an external type. When the touch sensor is of the external type, the touch panel and the display panel 110 may be separately manufactured or may be combined during an assembly process. The external-type touch panel may include a touch panel substrate and a plurality of touch electrodes on the touch panel substrate.

When the touch sensor is present inside the display panel 110, the touch sensor may be formed on the substrate SUB, together with signal lines and electrodes related to display driving, during the manufacturing process of the display panel 110.

The touch driving circuit may supply a touch driving signal to at least one of the plurality of touch electrodes and may sense at least one of the plurality of touch electrodes to generate touch sensing data.

The touch sensing circuit may perform touch sensing in a self-capacitance sensing scheme or a mutual-capacitance sensing scheme.

When the touch sensing circuit performs touch sensing in the self-capacitance sensing scheme, the touch sensing circuit may perform touch sensing based on capacitance between each touch electrode and the touch object (e.g., finger or pen). According to the self-capacitance sensing scheme, each of the plurality of touch electrodes may serve both as a driving touch electrode and as a sensing touch electrode. The touch driving circuit may drive all or some of the plurality of touch electrodes and sense all or some of the plurality of touch electrodes.

When the touch sensing circuit performs touch sensing in the mutual-capacitance sensing scheme, the touch sensing circuit may perform touch sensing based on capacitance between the touch electrodes. According to the mutual-capacitance sensing scheme, the plurality of touch electrodes are divided into driving touch electrodes and sensing touch electrodes. The touch driving circuit may drive the driving touch electrodes and sense the sensing touch electrodes.

The touch driving circuit and the touch controller included in the touch sensing circuit may be implemented as separate devices or as a single device. The touch driving circuit and the data driving circuit may be implemented as separate devices or as a single device.

The display device 100 may further include a power supply circuit for supplying various types of power to the display driving circuit and/or the touch sensing circuit. The power supply circuit may supply various voltages and power voltages related to display driving to the display driving circuit or display panel 110.

The display device 100 according to embodiments of the disclosure may be a mobile terminal, such as a smart phone or a tablet, or a monitor or television (TV) in various sizes but, without limited thereto, may be a display in various types and various sizes capable of displaying information or images.

The display device 100 according to embodiments of the disclosure may further include an electronic device such as a camera (image sensor), a detection sensor, or the like. For example, the detection sensor may be a sensor that detects an object or a human body by receiving light such as infrared rays, ultrasonic waves, or ultraviolet rays, but embodiments of the disclosure are not limited thereto.

Hereinafter, a first selection circuit MUX1 and a second selection circuit MUX2 included in a display device 100 of FIG. 1 are described.

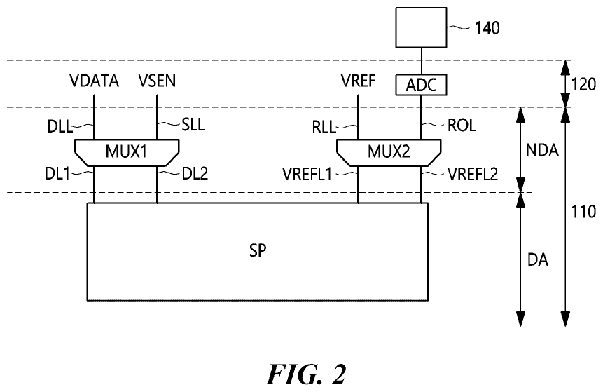

FIG. 2 illustrates a first selection circuit MUX1 and a second selection circuit MUX2 of a display device 100 according to embodiments of the disclosure.

Referring to FIG. 2, the subpixel SP may be disposed in the display area DA. A plurality of subpixels SP may be included in the display area DA. The first selection circuit MUX1 and the second selection circuit MUX2 may be disposed in the non-display area NDA.

Alternatively, the first selection circuit MUX1 and the second selection circuit MUX2 may be disposed in the data driving circuit 120. The first selection circuit MUX1 and the second selection circuit MUX2 may be composed of a multiplexer or a demultiplexer. However, the disclosure is not limited thereto. The analog-to-digital converter ADC may be disposed in the data driving circuit 120. The analog-to-digital converter ADC may be electrically connected to the controller 140.

The first selection circuit MUX1 and the data driving circuit 120 may be electrically connected through a data link line DLL to which the data voltage VDATA is applied and a sensing driving link line SLL to which the sensing driving voltage VSEN is applied.

The first selection circuit MUX and the subpixel SP may be electrically connected through the first data line DL1 and the second data line DL2.

The second selection circuit MUX2 and the data driving circuit 120 may be electrically connected through a reference voltage link line RLL to which the reference voltage VREF is applied and a readout line ROL connected to the analog-to-digital converter ADC.

The second selection circuit MUX and the subpixel SP may be electrically connected through the first reference voltage line VREFL1 and the second reference voltage line VREFL2.

The first selection circuit MUX1 may electrically connect one of the data link line DLL and the sensing driving link line SLL and one of the first data line DL1 and the second data line DL2. Accordingly, the number of lines connected between the subpixel SP and the data driving circuit 120 may be decreased.

The second selection circuit MUX2 may electrically connect one of the reference voltage link line RLL and the readout line ROL and one of the first reference voltage line VREFL1 and the second reference voltage line VREFL2. Accordingly, the number of lines connected between the subpixel SP and the data driving circuit 120 may be decreased.

As the first reference voltage line VREFL1 and the second reference voltage line VREFL2 are connected to the readout line ROL, a voltage for sensing a characteristic value of the driving transistor may be output to the readout line ROL from the first reference voltage line VREFL1 or the second reference voltage line VREFL2. The voltage output to the readout line ROL may be input to the analog-to-digital converter ADC. For example, a voltage or current charged in a capacitor connected to the readout line ROL may be input to the analog-to-digital converter ADC.

The analog-to-digital converter ADC may convert the input voltage or current into digital sensing data. The analog-to-digital converter ADC may provide the sensing data to the controller 140.

The controller 140 may calculate a compensation value based on the provided sensing data. The compensation value may be stored in the memory. The data voltage VDATA applied to the subpixel SP may be changed based on the compensation value. The changed data voltage VDATA may be output to the data lines (e.g., the first data line DL1 and the second data line DL2).

As the output data voltage VDATA is provided to the subpixel SP, the driving efficiency of the deteriorated driving transistor may increase, and luminance unevenness of the subpixel SP may be prevented or decreased.

Hereinafter, the subpixel SP to which the changed data voltage VDATA is supplied is described.

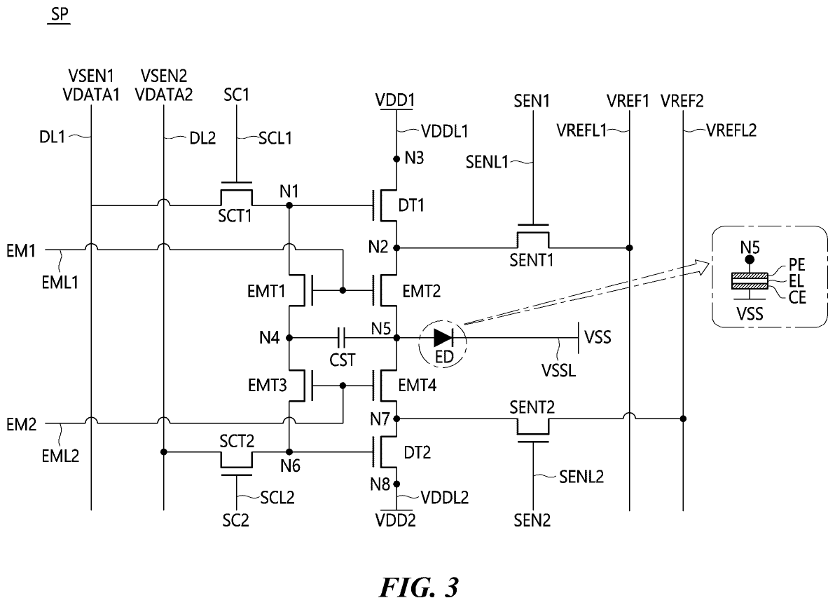

FIG. 3 illustrates a subpixel SP of a display device 100 according to embodiments of the disclosure.

Referring to FIG. 3, the subpixel SP may include a light emitting element ED including a pixel electrode PE, an intermediate layer EL, and a common electrode CE. The subpixel SP may include a first driving transistor DT1 for controlling the connection between the second node N2 and the third node N3 according to a voltage applied to the first node N1, and driving the light emitting element ED.

The subpixel SP may include a first scan transistor SCT1 that controls connection between a first data line DL1 among the plurality of data lines and the first node N1 according to a first scan signal SC1. The subpixel SP may include a first sensing transistor SENT1 that controls connection between the first reference voltage line VREFL1 among the plurality of reference voltage lines and the second node N2 according to the first sensing signal SEN1.

The subpixel SP may include a first emission control transistor EMT1 that controls connection between the first node N1 and the fourth node N4 according to the first emission control signal EM1. The subpixel SP may include a second emission control transistor EMT2 that controls connection between the second node N2 and the fifth node N5 according to the first emission control signal EM1. The first gate node of the first emission control transistor EMT1 and the second gate node of the second emission control transistor EMT2 may be connected to each other.

The subpixel SP may include a storage capacitor CST electrically connected between the fourth node N4 and the fifth node N5. The storage capacitor CST may not be a parasitic capacitor (e.g., Cgs and Cgd), which is an internal capacitor, but may be an external capacitor intentionally designed outside the driving transistor.

The subpixel SP may include a second driving transistor DT2 for controlling connection between the seventh node N7 and the eighth node N8 according to the voltage applied to the sixth node N6 and driving the light emitting element ED.

The subpixel SP may include a second scan transistor SCT2 for controlling connection between a second data line DL2 among the plurality of data lines and the sixth node N6 according to the second scan signal SC2. The subpixel SP may include a second sensing transistor SENT2 that controls connection between a second reference voltage line VREFL2 among the plurality of reference voltage lines and the seventh node N7 according to the second sensing signal SEN2.

The subpixel SP may include a third emission control transistor IMT3 that controls connection between the sixth node N6 and the fourth node N4 according to the second emission control signal EM2. The subpixel SP may include a fourth emission control transistor EMT4 that controls connection between the seventh node N7 and the fifth node N5 according to the second emission control signal EM2. The third gate node of the third emission control transistor EMT3 and the fourth gate node of the fourth emission control transistor EMT4 may be connected to each other.

The first driving transistor DT1, the second driving transistor DT2, the first scan transistor SCT1, the second scan transistor SCT2, the first sensing transistor SENT1, the second sensing transistor SENT2, the first emission control transistor EMT1, the second emission control transistor EMT2, the third emission control transistor EMT3, and the fourth emission control transistor EMT4 may be N-type transistors or P-type transistors. Hereinafter, for convenience of description, the first driving transistor DT1, the second driving transistor DT2, the first scan transistor SCT1, the second scan transistor SCT2, the first sensing transistor SENT1, the second sensing transistor SENT2, the first emission control transistor EMT1, the second emission control transistor EMT2, the third emission control transistor EMT3, and the fourth emission control transistor EMT4 may be described as N-type transistors.

Hereinafter, a connection relationship between components included in the subpixel SP of the disclosure is described.

Referring to FIG. 3, the light emitting element ED may be connected between the low-potential driving voltage line VSSL to which the low-potential driving voltage VSS is applied and the fifth node N5. The drain node or the source node of the first driving transistor DT1 corresponds to the third node N3 and may be electrically connected to the first high-potential driving voltage line VDDL1 to which the first high-potential driving voltage VDD1 is applied. The source node or the drain node of the first driving transistor DT1 may be a node corresponding to the second node N2.

The drain node or the source node of the first scan transistor SCT1 may be electrically connected to the first data line DL1 to which the first data voltage VDATA1 or the first sensing driving voltage VSEN1 is applied. The gate node of the first scan transistor SCT1 may be electrically connected to the first scan signal line SCL1 to which the first scan signal SC1 is applied. The source node or the gate node of the first scan transistor SCT1 may be a node corresponding to the first node N1. The first node N1 may be a node corresponding to the gate node of the first driving transistor DT1 and the drain node or the source node of the first emission control transistor EMT1. The source node or the drain node of the first emission control transistor EMT1 may be a node corresponding to the fourth node N4.

The drain node or the source node of the first sensing transistor SENT1 may be electrically connected to the first reference voltage line VREFL1 to which the first reference voltage VREF1 is applied. The gate node of the first sensing transistor SENT1 may be electrically connected to the first sensing signal line SENL1 to which the first sensing signal SEN1 is applied.

The source node or the drain node of the first sensing transistor SENT1 may be a node corresponding to the second node N2.

The second node N2 may be a node corresponding to the source node or the drain node of the first driving transistor DT1. The second node N2 may be a node corresponding to the drain node or the source node of the second emission control transistor EMT2. The source node or the drain node of the second emission control transistor EMT2 may be a node corresponding to the fifth node N5.

The gate node of the first emission control transistor EMT1 and the gate node of the second emission control transistor EMT2 may be connected to each other, and may be electrically connected to the first emission control signal line EML1 to which the first emission control signal EM1 is applied. The turn-on or turn-off state of the first emission control transistor EMT1 and the second emission control transistor EMT2 may be changed according to the first emission control signal EM1.

The storage capacitor CST may be electrically connected between the fourth node N4 and the fifth node N5.

Referring to FIG. 3, the drain node or the source node of the second driving transistor DT2 may correspond to the eighth node N8 and may be electrically connected to the high-potential driving voltage line VDDL2 to which the second high-potential driving voltage VDD2 may be applied. The source node or the drain node of the second driving transistor DT2 may be a node corresponding to the seventh node N7.

The drain node or the source node of the second scan transistor SCT2 may be electrically connected to the second data line DL2 to which the second data voltage VDATA2 or the second sensing driving voltage VSEN2 is applied. The gate node of the second scan transistor SCT2 may be electrically connected to the second scan signal line SCL2 to which the second scan signal SC2 is applied. The source node or the gate node of the second scan transistor SCT2 may be a node corresponding to the sixth node N6. The sixth node N6 may be a node corresponding to the gate node of the second driving transistor DT2 and the drain node or the source node of the third emission control transistor EMT3. The source node or the drain node of the third emission control transistor EMT3 may be a node corresponding to the fourth node N4.

The drain node or the source node of the second sensing transistor SENT2 may be electrically connected to the second reference voltage line VREFL2 to which the second reference voltage VREF2 is applied. The gate node of the second sensing transistor SENT2 may be electrically connected to the second sensing signal line SENL2 to which the second sensing signal SEN2 is applied. The source node or drain node of the second sensing transistor SENT2 may be a node corresponding to the seventh node N7.

The seventh node N7 may be a node corresponding to the source node or the drain node of the second driving transistor DT2. The seventh node N7 may be a node corresponding to the drain node or the source node of the fourth emission control transistor EMT4. The source node or the drain node of the fourth emission control transistor EMT4 may be a node corresponding to the fifth node N5.

The gate node of the third emission control transistor EMT3 and the gate node of the fourth emission control transistor EMT4 may be connected to each other, and may be electrically connected to the second emission control signal line EML2 to which the second emission control signal EM2 is applied. The turn-on or turn-off state of the third emission control transistor EMT3 and the fourth emission control transistor EMT4 may be changed according to the second emission control signal EM2.

Hereinafter, a timing diagram for driving the subpixel SP of the disclosure is described.

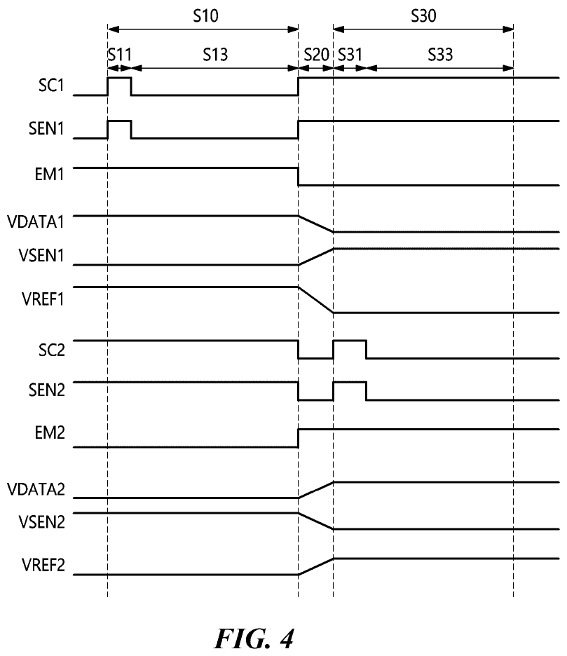

FIG. 4 illustrates a timing diagram for driving a subpixel SP of a display device 100 according to embodiments of the disclosure.

According to the driving method of the display device 100 according to embodiments of the disclosure, each driving period of the subpixel SP may include a first driving period S10, a second driving period S30, a third driving period S11, a fourth driving period S13, a fifth driving period S31, a sixth driving period S33, and a seventh driving period S20.

The first driving period S10 may be referred to as a period for sensing a characteristic value of the second driving transistor DT2. The second driving period S30 may be referred to as a period for sensing a characteristic value of the first driving transistor DT1. The third driving period S11 may be referred to as an addressing period for driving the first driving transistor DT1. The fourth driving period S13 may be referred to as an emission period using the first driving transistor DT1. The fifth driving period S31 may be referred to as an addressing period for driving the second driving transistor DT2. The sixth driving period S33 may be referred to as an emission period using the second driving transistor DT2. The seventh driving period S20 may be referred to as a blank period.

In the display device 100 according to embodiments of the disclosure, during the first driving period S10, the first emission control signal EM1 may have a turn-on level voltage, and the second emission control signal EM2 may have a turn-off level voltage.

During the first driving period S10, the first data voltage VDATA1 may have a data voltage VDATA corresponding to an image signal, and the second sensing driving voltage VSEN2 may have a voltage corresponding to the sensing driving voltage VSEN.

During the first driving period S10, the second scan signal SC2 and the second sensing signal SEN2 may have a turn-on level voltage. The first reference voltage VREF1 may have a voltage corresponding to the reference voltage VREF.

During the second driving period S30, the second emission control signal EM2 may have a turn-on level voltage, and the first emission control signal EM1 may have a turn-off level voltage.

During the second driving period S30, the second data voltage VDATA2 may have a data voltage VDATA corresponding to an image signal, and the first sensing driving voltage VSEN1 may have a voltage corresponding to the sensing driving voltage VSEN.

During the second driving period S30, the first scan signal SC1 and the first sensing signal SEN1 may have a turn-on level voltage. The second reference voltage VREF2 may have a voltage corresponding to the reference voltage VREF.

During the third driving period S11, the first scan signal SC1 and the first sensing signal SEN1 may have a turn-on level voltage. During the fourth driving period S13, the first scan signal SC1 and the first sensing signal SEN1 may have a turn-off level voltage.

During the fifth driving period S31, the second scan signal SC2 and the second sensing signal SEN2 may have a turn-on level voltage. During the sixth driving period S33, the second scan signal SC2 and the second sensing signal SEN2 may have a turn-off level voltage.

During the seventh driving period S20, the first scan signal SC1, the first sensing signal SEN1, and the second emission control signal EM2 may have a turn-on level voltage. During the seventh driving period S20, the first emission control signal EM1, the second scan signal SC2, and the second sensing signal SEN2 may have a turn-off level voltage.

During the seventh driving period S20, the voltage applied to the first data line DL1 may change from the first data voltage VDATA1 corresponding to the data voltage VDATA to the first sensing voltage VSEN1 corresponding to the sensing driving voltage VSEN. During the seventh driving period S20, the voltage applied to the second data line DL2 may be changed from the second sensing voltage VSEN2 corresponding to the sensing driving voltage VSEN to the second data voltage VDATA2 corresponding to the data voltage VDATA.

During the seventh driving period S20, the voltage applied to the first reference voltage line VREFL1 may be changed from the first reference voltage VREF1 corresponding to the reference voltage VREF to a voltage for sensing a characteristic value of the first driving transistor DT1. During the seventh driving period S20, the voltage applied to the second reference voltage line VREFL2 may be changed from a voltage for sensing a characteristic value of the second driving transistor DT2 to a second reference voltage VREF2 corresponding to the reference voltage VREF.

Hereinafter, a driving method for each driving period of the display device 100 according to an embodiment of the disclosure is described. During the first driving period S10, the display device 100 may control the light emission of the light emitting element ED using the first driving transistor DT1 and sense a voltage for sensing a characteristic value of the second driving transistor DT2. During the second driving period S30, the display device 100 may control the light emission of the light emitting element ED using the second driving transistor DT2 and sense a voltage for sensing a characteristic value of the first driving transistor DT1. Accordingly, the first driving transistor DT1 and the second driving transistor DT2 may alternately control the light emission of the light emitting element ED, and a sensing period for compensating for a change in the characteristic value of the first driving transistor DT1 and the second driving transistor DT2 is not required.

During the first driving period S10, the first selection circuit MUX1 may electrically connect the data link line DLL and the first data line DL1. As the data link line DLL and the first data line DL1 are connected, the data voltage VDATA may be applied to the first data line DL1.

The first selection circuit MUX1 may electrically connect the sensing driving link line SLL and the second data line DL2. As the sensing driving link line SLL and the second data line DL2 are electrically connected to each other, the sensing driving voltage VSEN may be applied to the second data line DL2.

During the first driving period S10, the second selection circuit MUX2 may electrically connect the reference voltage link line RLL and the first reference voltage line VREFL1. As the reference voltage link line RLL and the first reference voltage line VREFL1 are electrically connected to each other, the reference voltage VREF may be applied to the first reference voltage line VREFL1. The second selection circuit MUX2 may electrically connect the readout line ROL to the second reference voltage line VREFL2. As the readout line ROL and the second reference voltage line VREFL2 are electrically connected to each other, the voltage input to the second reference voltage line VREFL2 may be applied to the readout line ROL. The voltage applied to the readout line ROL may be applied to the analog-to-digital converter ADC.

During the second driving period S30, the first selection circuit MUX1 may electrically connect the data link line DLL and the second data line DL2. As the data link line DLL and the second data line DL2 are electrically connected to each other, the data voltage VDATA may be applied to the second data line DL2. The first selection circuit MUX1 may electrically connect the sensing driving link line SLL and the first data line DL1. As the sensing driving link line SLL and the first data line DL1 are electrically connected to each other, the sensing driving voltage VSEN may be applied to the first data line DL1.

During the second driving period S30, the second selection circuit MUX2 may electrically connect the reference voltage link line RLL to the second reference voltage. As the reference voltage link line RLL and the second reference voltage line VREFL2 are electrically connected to each other, the reference voltage VREF may be applied to the second reference voltage line VREFL2. The second selection circuit MUX2 may electrically connect the readout line ROL to the first reference voltage line VREFL1. As the readout line ROL and the first reference voltage line VREFL1 are electrically connected to each other, the voltage input to the first reference voltage line VREFL1 may be applied to the readout line ROL. The voltage applied to the readout line ROL may be applied to the analog-to-digital converter ADC.

The data voltage VDATA applied from the data link line DLL may be a first data voltage VDATA1 or a second data voltage VDATA2. The first data voltage VDATA1 and the second data voltage VDATA2 may have the same voltage level. During the first driving period S10, the first data voltage VDATA1 may be a data voltage VDATA corresponding to an image signal changed using a compensation value for compensating for deterioration according to a change in the characteristic value of the first driving transistor DT1. During the second driving period S30, the second data voltage VDATA2 may be a data voltage VDATA corresponding to an image signal changed using a compensation value for compensating for deterioration according to a change in the characteristic value of the second driving transistor DT2.

The sensing driving voltage VSEN applied from the sensing driving link line SLL may be a first sensing driving voltage VSEN1 or a second sensing driving voltage VSEN2. The first sensing driving voltage VSEN1 and the second sensing driving voltage VSEN2 may have the same voltage level. The reference voltage VREF applied from the reference voltage link line RRL may be a first reference voltage VREF1 or a second reference voltage VREF2. The first reference voltage VREF1 and the second reference voltage VREF2 may have the same voltage level.

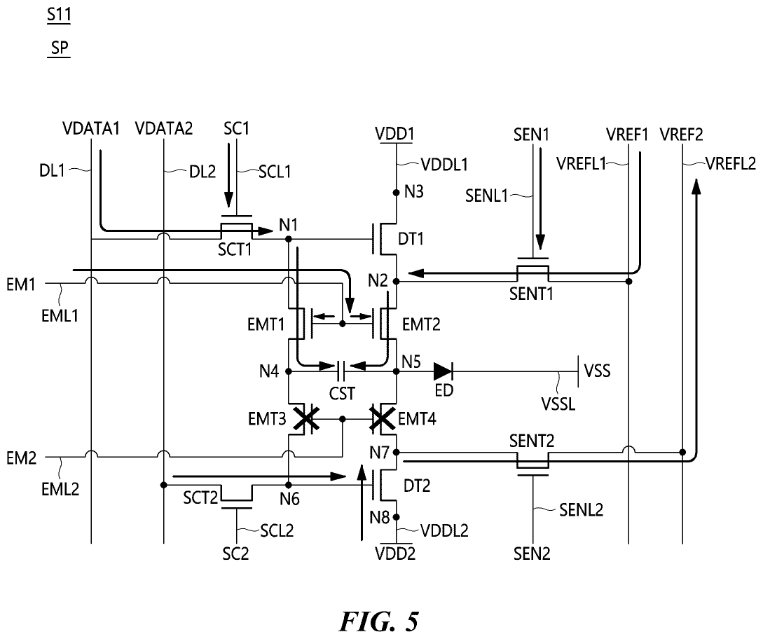

FIG. 5 illustrates a third driving period S11 of a first driving period S10 in a driving method of a subpixel SP of a display device 100 according to embodiments of the disclosure.

Referring to FIG. 5, during the third driving period S11, as the first emission control signal EM1 having a turn-on level is applied to the first emission control signal line EML1, the first emission control transistor EMT1 and the second emission control transistor EMT2 may be turned on. As the second emission control signal EM2 having a turn-off level is applied to the second emission control signal line EML2, the third emission control transistor EMT3 and the fourth emission control transistor EMT4 may be turned off.

During the third driving period S11, as the first scan signal SC1 having a turn-on level is applied to the first scan signal line SCL1, the first scan transistor SCT1 may be turned on. As the first scan transistor SCT1 is turned on, the first data voltage VDATA1 corresponding to the image signal applied from the first data line DL1 may be applied to the first node N1. As the first emission control transistor EMT1 is turned on, the first data voltage VDATA1 applied to the first node N1 may be applied to the fourth node N4.

During the third driving period S11, as the first sensing signal SEN1 having a turn-on level voltage is applied to the first sensing signal line SENL1, the first sensing transistor SENT1 may be turned on. As the first sensing transistor SENT1 is turned on, the first reference voltage VREF1 applied from the first reference voltage line VREFL1 may be applied to the second node N2. As the second emission control transistor EMT2 is turned on, the voltage applied to the second node N2 may be applied to the fifth node N5. Accordingly, the storage capacitor CST connected between the fourth node N4 and the fifth node N5 may be charged.

As the second scan signal SC2 having a turn-on level voltage is applied to the second scan signal line SCL2 during the third driving period S11, the second scan transistor SCT2 may be turned on. As the second scan transistor SCT2 is turned on, the second sensing driving voltage VSEN2 applied from the second data line DL2 may be applied to the sixth node N6.

As the second sensing driving voltage VSEN2 is applied to the sixth node N6, a current may flow from the eighth node N8 of the second driving transistor DT2 to the seventh node N7 of the second driving transistor DT2.

During the third driving period S11, as the second sensing signal SEN2 having a turn-on level voltage is applied to the second sensing signal line SENL2, the second sensing transistor SENT2 may be turned on. As the second sensing transistor SENT2 is turned on, a current may flow from the seventh node N7 to the second reference voltage line VREFL2.

The characteristic value of the second driving transistor DT2 may be sensed using the current flowing to the second reference voltage line VREFL2.

Hereinafter, for convenience of description, the resistances of the first emission control transistor EMT1, the second emission control transistor EMT2, the third emission control transistor EMT3, and the fourth emission control transistor EMT4 may be ignored. However, it is not intended to exclude circumstances in which the resistances of the first emission control transistor EMT1, the second emission control transistor EMT2, the third emission control transistor EMT3, and the fourth emission control transistor EMT4 exist, and the first emission control transistor EMT1, the second emission control transistor EMT2, the third emission control transistor EMT3, and the fourth emission control transistor EMT4 may have some resistance components even in the turn-on state.

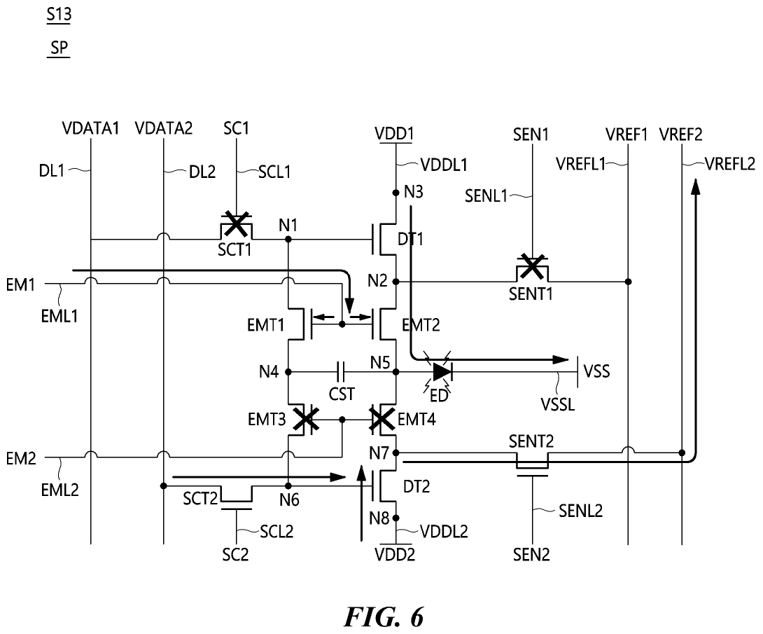

FIG. 6 illustrates a fourth driving period S13 of a first driving period S10 in a driving method of a subpixel SP of a display device 100 according to embodiments of the disclosure.

Referring to FIG. 6, during the fourth driving period S13, as the first emission control signal EM1 having a turn-on level is applied to the first emission control signal line EML1, the first emission control transistor EMT1 and the second emission control transistor EMT2 may be turned on. As the second emission control signal EM2 having a turn-off level is applied to the second emission control signal line EML2, the third emission control transistor EMT3 and the fourth emission control transistor EMT4 may be turned off.

During the fourth driving period S13, as the first scan signal SC1 having a turn-off level is applied to the first scan signal line SCL1, the first scan transistor SCT1 may be turned off. During the fourth driving period S13, as the first sensing signal SEN1 having a turn-off level voltage is applied to the first sensing signal line SENL1, the first sensing transistor SENT1 may be turned off.

As the first scan transistor SCT1 and the first sensing transistor SENT1 are turned off, the first node N1, the second node N2, the fourth node N4, and the fifth node N5 may be electrically floated, and voltage fluctuations may occur. Accordingly, a current may flow from the third node N3 of the first driving transistor DT1 to the light emitting element ED. As a current flows to the light emitting element ED, the light emitting element ED may emit light.

As the second scan signal SC2 having a turn-on level voltage is applied to the second scan signal line SCL2 during the fourth driving period S13, the second scan transistor SCT2 may be turned on. As the second scan transistor SCT2 is turned on, the second sensing driving voltage VSEN2 applied from the second data line DL2 may be applied to the sixth node N6.

As the second sensing driving voltage VSEN2 is applied to the sixth node N6, a current may flow from the eighth node N8 of the second driving transistor DT2 to the seventh node N7 of the second driving transistor DT2.

During the fourth driving period S13, as the second sensing signal SEN2 having a turn-on level voltage is applied to the second sensing signal line SENL2, the second sensing transistor SENT2 may be turned on. As the second sensing transistor SENT2 is turned on, a current may flow from the seventh node N7 to the second reference voltage line VREFL2.

The characteristic value of the second driving transistor DT2 may be sensed using the current flowing to the second reference voltage line VREFL2. Accordingly, while the characteristic value of the second driving transistor DT2 is sensed, the light emitting element ED may emit light through the current flowing from the first driving transistor DT1.

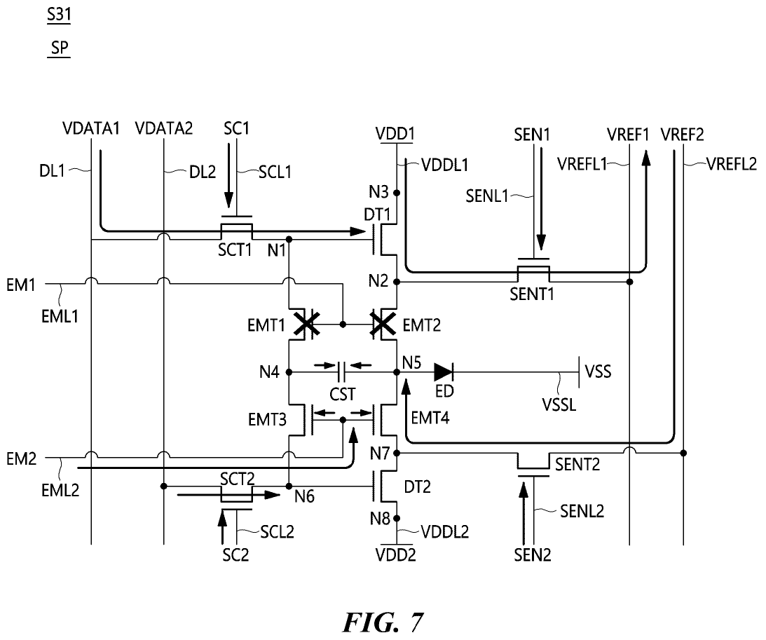

FIG. 7 illustrates a fifth driving period S31 of a second driving period S30 in a driving method of a subpixel SP of a display device 100 according to embodiments of the disclosure.

Referring to FIG. 7, during the fifth driving period S31, as the second emission control signal EM2 having a turn-on level is applied to the second emission control signal line EML2, the third emission control transistor EMT3 and the fourth emission control transistor EMT4 may be turned on. As the first emission control signal EM1 having a turn-off level is applied to the first emission control signal line EML1, the first emission control transistor EMT1 and the second emission control transistor EMT2 may be turned off.

During the fifth driving period S31, as the second scan signal SC2 having a turn-on level is applied to the second scan signal line SCL2, the second scan transistor SCT2 may be turned on. As the second scan transistor SCT2 is turned on, a second data voltage VDATA2 corresponding to an image signal applied from the second data line DL2 may be applied to the sixth node N6. As the third emission control transistor EMT3 is turned on, the second data voltage VDATA2 applied to the sixth node N6 may be applied to the fourth node N4.

During the fifth driving period S31, as the second sensing signal SEN2 having a turn-on level voltage is applied to the second sensing signal line SENL2, the second sensing transistor SENT2 may be turned on. As the second sensing transistor SENT2 is turned on, the second reference voltage VREF2 applied from the second reference voltage line VREFL2 may be applied to the seventh node N7. As the fourth emission control transistor EMT4 is turned on, the voltage applied to the seventh node N7 may be applied to the fifth node N5. Accordingly, the storage capacitor CST connected between the fourth node N4 and the fifth node N5 may be charged.

As the first scan signal SC1 having a turn-on level voltage is applied to the first scan signal line SCL1 during the fifth driving period S31, the first scan transistor SCT2 may be turned on. As the first scan transistor SCT1 is turned on, the first sensing driving voltage VSEN1 applied from the first data line DL1 may be applied to the first node N1.

As the first sensing driving voltage VSEN1 is applied to the first node N1, a current may flow from the third node N3 of the first driving transistor DT1 to the second node N2 of the first driving transistor DT1.

During the fifth driving period S31, as the first sensing signal SEN1 having a turn-on level voltage is applied to the first sensing signal line SENL1, the first sensing transistor SENT1 may be turned on. As the first sensing transistor SENT1 is turned on, a current may flow from the second node N2 to the first reference voltage line VREFL1.

The characteristic value of the second driving transistor DT2 may be sensed using the current flowing to the second reference voltage line VREFL2. Accordingly, while the characteristic value of the second driving transistor DT2 is sensed, the light emitting element ED may emit light through the current flowing from the first driving transistor DT1.

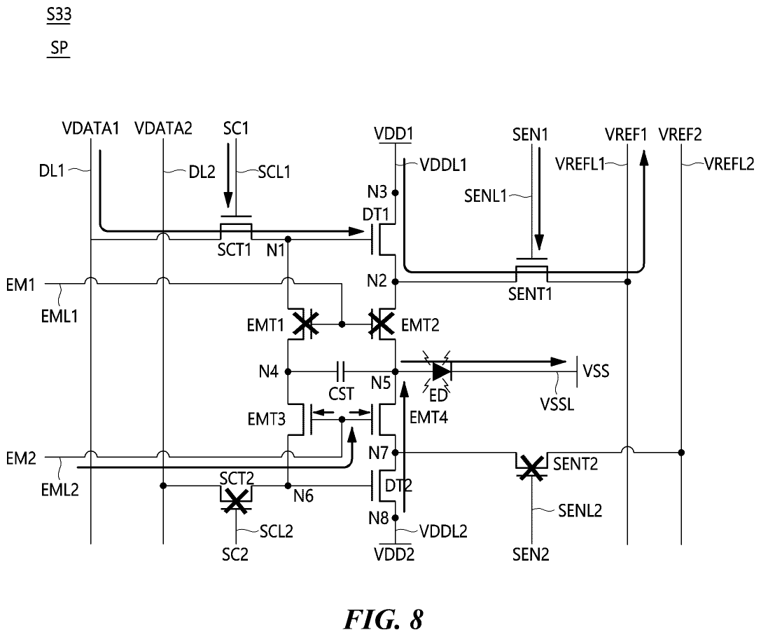

FIG. 8 illustrates a sixth driving period S33 of a second driving period S30 in a driving method of a subpixel SP of a display device 100 according to embodiments of the disclosure.

Referring to FIG. 8, during the sixth driving period S33, as the second emission control signal EM2 having a turn-on level is applied to the second emission control signal line EML2, the third emission control transistor EMT3 and the fourth emission control transistor EMT4 may be turned on. As the first emission control signal EM1 having a turn-off level is applied to the first emission control signal line EML1, the first emission control transistor EMT1 and the second emission control transistor EMT2 may be turned off.

During the sixth driving period S33, as the second scan signal SC2 having a turn-off level is applied to the second scan signal line SCL2, the second scan transistor SCT2 may be turned off. During the sixth driving period S33, as the second sensing signal SEN2 having the turn-off level voltage is applied to the second sensing signal line SENL2, the second sensing transistor SENT2 may be turned off.

As the second scan transistor SCT2 and the second sensing transistor SENT2 are turned off, the sixth node N6, the seventh node N7, the fourth node N4, and the fifth node N5 may be electrically floated, and voltage fluctuations may occur. Accordingly, a current may flow from the eighth node N8 of the second driving transistor DT2 to the light emitting element ED. As a current flows to the light emitting element ED, the light emitting element ED may emit light.

During the sixth driving period S33, as the first scan signal SC1 having a turn-on level voltage is applied to the first scan signal line SCL1, the first scan transistor SCT1 may be turned on. As the first scan transistor SCT1 is turned on, the first sensing driving voltage VSEN1 applied from the first data line DL1 may be applied to the first node N1.

As the first sensing driving voltage VSEN1 is applied to the first node N1, a current may flow from the third node N3 of the first driving transistor DT1 to the second node N2 of the first driving transistor DT1.

During the sixth driving period S33, as the first sensing signal SEN1 having a turn-on level voltage is applied to the first sensing signal line SENL1, the first sensing transistor SENT1 may be turned on. As the first sensing transistor SENT1 is turned on, a current may flow from the second node N2 to the first reference voltage line VREFL1.

The characteristic value of the first driving transistor DT1 may be sensed using the current flowing to the first reference voltage line VREFL1. Accordingly, while the characteristic value of the first driving transistor DT1 is sensed, the light emitting element ED may emit light through the current flowing from the second driving transistor DT2.

Embodiments of the disclosure described above are briefly described below.

A display panel may comprise a plurality of subpixels, a plurality of data lines, and a plurality of reference voltage lines.

Each of the plurality of subpixels may include a light emitting element including a pixel electrode, an intermediate layer, and a common electrode, a first driving transistor controlling connection between a second node and a third node according to a voltage applied to a first node to drive the light emitting element, a first scan transistor controlling connection between a first data line among the plurality of data lines and the first node according to a first scan signal, a first sensing transistor controlling connection between a first reference voltage line among the plurality of reference voltage lines and the second node according to a first sensing signal, a first emission control transistor controlling connection between the first node and a fourth node according to a first emission control signal, a second emission control transistor controlling connection between the second node and a fifth node according to the first emission control signal, and a storage capacitor electrically connected between the fourth node and the fifth node.

A first gate node of the first emission control transistor and a second gate node of the second emission control transistor may be connected.

The display device may further comprise a second driving transistor controlling connection between a seventh node and an eighth node according to a voltage applied to a sixth node to drive the light emitting element, a second scan transistor controlling connection between a second data line among the plurality of data lines and the sixth node according to a second scan signal, a second sensing transistor controlling connection between a second reference voltage line among the plurality of reference voltage lines and the seventh node according to a second sensing signal, a third emission control transistor controlling connection between the sixth node and the fourth node according to a second emission control signal, and a fourth emission control transistor controlling connection between the seventh node and the fifth node according to the second emission control signal.

A third gate node of the third emission control transistor and a fourth gate node of the fourth emission control transistor may be connected.

The display device may comprise a data link line to which a data voltage is applied, a sensing driving link line to which a sensing driving voltage is applied, a reference voltage link line to which a reference voltage is applied, an analog-to-digital converter, a readout line connected to the analog-to-digital converter, a first selection circuit electrically connecting one of the data link line and the sensing driving link line with one of the first data line and the second data line, and a second selection circuit electrically connecting one of the reference voltage link line and the readout line with one of the first reference voltage line and the second reference voltage line.

The display device may comprise a first driving period and a second driving period.

during the first driving period, the first selection circuit may electrically connect the data link line and the first data line and may electrically connect the second data line from the sensing driving link line.

The second selection circuit may electrically connect the reference voltage link line and the first reference voltage line and may electrically connect the readout line and the second reference voltage line.

During the second driving period, the first selection circuit may electrically connect the data link line and the second data line and may electrically connect the first data line from the sensing driving link line.

The second selection circuit may electrically connect the reference voltage link line and the second reference voltage line and may electrically connect the readout line and the first reference voltage line.

During the first driving period, the first emission control transistor and the second emission control transistor may be turned on as the first emission control signal having a turn-on level voltage is supplied to the first gate node and the second gate node.

During the first driving period, the first node and the fourth node may be electrically connected as the first emission control transistor is turned on, the second node and the fifth node may be electrically connected as the second emission control transistor is turned on.

During the first driving period, the third emission control transistor and the fourth emission control transistor may be turned off as the second emission control signal having a turn-off level is supplied to the third gate node and the fourth gate node.

During the first driving period, the sixth node and the fourth node may be electrically disconnected as the third emission control transistor is turned off, and the seventh node and the fifth node may be electrically disconnected as the fourth emission control transistor is turned off.

During the second driving period, the third emission control transistor and the fourth emission control transistor may be turned on as the second emission control signal having a turn-on level is supplied to the third gate node and the fourth gate node.

During the second driving period, the sixth node and the fourth node may be electrically connected as the third emission control transistor is turned on, the seventh node and the fifth node may be electrically connected as the fourth emission control transistor is turned on.

During the second driving period, the first emission control transistor and the second emission control transistor may be turned off as the first emission control signal having a turn-off level is supplied to the first gate node and the second gate node.

During the second driving period, the first node and the fourth node may be electrically disconnected as the first emission control transistor is turned off, and the second node and the fifth node may be electrically disconnected as the second emission control transistor is turned off.

During the first driving period, the second scan transistor may be turned on as the second scan signal having a turn-on level is supplied to a gate node of the second scan transistor.

During the first driving period, a second sensing driving voltage may be supplied from the second data line to the sixth node as the second scan transistor is turned on.

During the second driving period, the first scan transistor may be turned on as the first scan signal having a turn-on level is supplied to a gate node of the first scan transistor.

During the second driving period, a first sensing driving voltage may be supplied from the first data line to the first node as the first scan transistor is turned on.

During the first driving period, the second sensing transistor may be turned on as the second sensing signal having a turn-on level is supplied to a gate node of the second sensing transistor.

During the first driving period, a voltage may be applied from the seventh node to the second reference voltage line as the second sensing transistor is turned on.

During the second driving period, the first sensing transistor may be turned on as the first sensing signal having a turn-on level is supplied to a gate node of the first sensing transistor.

During the second driving period, a voltage may be applied from the second node to the first reference voltage line as the first sensing transistor is turned on.

The first driving period may include a third driving period and a fourth driving period.

During the third driving period, the first scan transistor may be turned on as the first scan signal having a turn-on level voltage is supplied to a gate node of the first scan transistor.

During the third driving period, a first data voltage may be supplied from the first data line to the first node as the first scan transistor is turned on.

During the third driving period, the first sensing transistor may be turned on as the first sensing signal having a turn-on level voltage is supplied to a gate node of the first sensing transistor.

During the third driving period, a second reference voltage may be supplied from the first reference voltage line to the second node as the first sensing transistor is turned on.

During the fourth driving period, the first scan transistor may be turned off as the first scan signal having a turn-off level voltage is supplied to a gate node of the first scan transistor.

During the fourth driving period, the first sensing transistor may be turned off as the first sensing signal having a turn-off level voltage is supplied to a gate node of the first sensing transistor.

During the fourth driving period, the first node and the second node may be electrically floated as the first scan transistor and the first sensing transistor are turned off.

During the fourth driving period, the second driving period may include a fifth driving period and a sixth driving period.

During the fifth driving period, the second scan transistor may be turned on as the second scan signal having a turn-on level voltage is supplied to a gate node of the second scan transistor.

During the fifth driving period, a second data voltage may be supplied from the second data line to the sixth node as the second scan transistor is turned on.

During the fifth driving period, the second sensing transistor may be turned on as the second sensing signal having a turn-on level voltage is supplied to a gate node of the second sensing transistor.

During the fifth driving period, a second reference voltage may be supplied from the second reference voltage line to the seventh node as the second sensing transistor is turned on.

During the sixth driving period, the second scan transistor may be turned off as the second scan signal having a turn-off level voltage is supplied to a gate node of the second scan transistor.

During the sixth driving period, the second sensing transistor may be turned off as the second sensing signal having a turn-off level voltage is supplied to a gate node of the second sensing transistor.

During the sixth driving period, the sixth node and the seventh node may be electrically floated as the second scan transistor and the second sensing transistor are turned off.

A display device may comprise a first subpixel, a first data line connected to the first subpixel, a second data line connected to the first subpixel, a first reference voltage line connected to the first subpixel, a second reference voltage line connected to the first subpixel, a data link line to which a data voltage is applied, a sensing driving link line to which a sensing driving voltage is applied, and a first selection circuit electrically connecting one of the data link line and the sensing driving link line with one of the first data line and the second data line.

The display device may comprise a reference voltage link line to which a reference voltage is applied, an analog-to-digital converter, a readout line connected to the analog-to-digital converter, and a second selection circuit electrically connecting one of the reference voltage link line and the readout line with one of the first reference voltage line and the second reference voltage line.

The first subpixel may include a light emitting element including a pixel electrode, an intermediate layer, and a common electrode, a first driving transistor controlling connection between a second node and a third node according to a voltage applied to a first node to drive the light emitting element, a first scan transistor controlling connection between a first data line among the plurality of data lines and the first node according to a first scan signal, a first sensing transistor controlling connection between a first reference voltage line among the plurality of reference voltage lines and the second node according to a first sensing signal, a first emission control transistor controlling connection between the first node and a fourth node according to a first emission control signal, a second emission control transistor controlling connection between the second node and a fifth node according to the first emission control signal, and a storage capacitor electrically connected between the fourth node and the fifth node.

A first gate node of the first emission control transistor and a second gate node of the second emission control transistor may be connected.

The first subpixel may include a light emitting element including a pixel electrode, a light emitting layer, and a common electrode, a first driving transistor controlling connection between the first driving voltage line and the pixel electrode according to a first gate voltage, and a second driving transistor controlling connection between the second driving voltage line and the pixel electrode according to a second gate voltage different from the first gate voltage.

A subpixel may comprise a light emitting element including a pixel electrode, a light emitting layer, and a common electrode, a first driving transistor controlling connection between the first driving voltage line and the pixel electrode according to a first gate voltage, and a second driving transistor controlling connection between the second driving voltage line and the pixel electrode according to a second gate voltage different from the first gate voltage.

The subpixel may further comprise a first emission control transistor connected between the first driving transistor and the pixel electrode and turned on or off according to a first emission control signal, a second emission control transistor having a second gate node connected to a first gate node of the first emission control transistor and turned on or off according to the first emission control signal, a third emission control transistor connected between the second driving transistor and the pixel electrode and turned on or off according to a second emission control signal, and a fourth emission control transistor having a fourth gate node connected to a third gate node of the third emission control transistor and turned on or off according to the second emission control signal.

The subpixel may comprise a first driving period and a second driving period.

During the first driving period, a first data voltage may be applied to a fifth gate node from a first data line electrically connected to the fifth gate node of the first driving transistor, and a second sensing driving voltage may be applied to a sixth gate node from a second data line electrically connected to the sixth gate node of the second driving transistor.

During the second driving period, a first sensing driving voltage may be applied to the fifth gate node from the first data line, and a second data voltage may be applied to the sixth gate node from the second data line.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a plurality of subpixels;
a plurality of data lines; and
a plurality of reference voltage lines,
wherein each of the plurality of subpixels includes:
a light emitting element including a pixel electrode, an intermediate layer, and a common electrode;
a first driving transistor connected between a second node and a third node and configured to switch based on a voltage applied to a first node to drive the light emitting element;
a first scan transistor connected between a first data line among the plurality of data lines and the first node and configured to switch based on a first scan signal;
a first sensing transistor connected between a first reference voltage line among the plurality of reference voltage lines and the second node and configured to switch a first sensing signal;
a first emission control transistor connected between the first node and a fourth node and configured to switch a first emission control signal;
a second emission control transistor connected between the second node and a fifth node and configured to switch the first emission control signal; and
a storage capacitor electrically connected between the fourth node and the fifth node, and
wherein a first gate node of the first emission control transistor and a second gate node of the second emission control transistor are connected.

2. The display device of claim 1, further comprising:
a second driving transistor connected between a seventh node and an eighth node and configured to switch a voltage applied to a sixth node to drive the light emitting element;
a second scan transistor connected between a second data line among the plurality of data lines and the sixth node and configured to switch a second scan signal;
a second sensing transistor connected between a second reference voltage line among the plurality of reference voltage lines and the seventh node and configured to switch a second sensing signal;
a third emission control transistor connected between the sixth node and the fourth node and configured to switch a second emission control signal; and
a fourth emission control transistor connected between the seventh node and the fifth node and configured to switch the second emission control signal, and
wherein a third gate node of the third emission control transistor and a fourth gate node of the fourth emission control transistor are connected.

3. The display device of claim 2, further comprising:
a data link line connected to receive a data voltage;
a sensing driving link line connected to receive a sensing driving voltage;
a reference voltage link line connected to receive a reference voltage;
an analog-to-digital converter;
a readout line connected to the analog-to-digital converter;
a first selection circuit electrically connecting one of the data link line or the sensing driving link line with one of the first data line or the second data line; and
a second selection circuit electrically connecting one of the reference voltage link line orthe readout line with one of the first reference voltage line or the second reference voltage line.

4. The display device of claim 3,
wherein during a first driving period, the first selection circuit electrically connects the data link line and the first data line and electrically connects the second data line and the sensing driving link line, and the second selection circuit electrically connects the reference voltage link line and the first reference voltage line and electrically connects the readout line and the second reference voltage line.

5. The display device of claim 4, wherein during a second driving period, the first selection circuit electrically connects the data link line and the second data line and electrically connects the first data line and the sensing driving link line, and the second selection circuit electrically connects the reference voltage link line and the second reference voltage line and electrically connects the readout line and the first reference voltage line.

6. The display device of claim 2,
wherein during a first driving period, the first emission control transistor and the second emission control transistor are turned on as the first emission control signal having a turn-on level voltage is supplied to the first gate node and the second gate node, the first node and the fourth node are electrically connected as the first emission control transistor is turned on, the second node and the fifth node are electrically connected as the second emission control transistor is turned on, the third emission control transistor and the fourth emission control transistor are turned off as the second emission control signal having a turn-off level is supplied to the third gate node and the fourth gate node, the sixth node and the fourth node are electrically disconnected as the third emission control transistor is turned off, and the seventh node and the fifth node are electrically disconnected as the fourth emission control transistor is turned off.

7. The display device of claim 6, wherein during a second driving period, the third emission control transistor and the fourth emission control transistor are turned on as the second emission control signal having a turn-on level is supplied to the third gate node and the fourth gate node, the sixth node and the fourth node are electrically connected as the third emission control transistor is turned on, the seventh node and the fifth node are electrically connected as the fourth emission control transistor is turned on, the first emission control transistor and the second emission control transistor are turned off as the first emission control signal having a turn-off level is supplied to the first gate node and the second gate node, the first node and the fourth node are electrically disconnected as the first emission control transistor is turned off, and the second node and the fifth node are electrically disconnected as the second emission control transistor is turned off.

8. The display device of claim 7, wherein during the first driving period, the second scan transistor is turned on as the second scan signal having a turn-on level is supplied to a gate node of the second scan transistor, and a second sensing driving voltage is supplied from the second data line to the sixth node as the second scan transistor is turned on, and during the second driving period, the first scan transistor is turned on as the first scan signal having a turn-on level is supplied to a gate node of the first scan transistor, and a first sensing driving voltage is supplied from the first data line to the first node as the first scan transistor is turned on.

9. The display device of claim 7, wherein during the first driving period, the second sensing transistor is turned on as the second sensing signal having a turn-on level is supplied to a gate node of the second sensing transistor, and a voltage is applied from the seventh node to the second reference voltage line as the second sensing transistor is turned on, and during the second driving period, the first sensing transistor is turned on as the first sensing signal having a turn-on level is supplied to a gate node of the first sensing transistor, and a voltage is applied from the second node to the first reference voltage line as the first sensing transistor is turned on.

10. The display device of claim 7, wherein the first driving period includes a third driving period and a fourth driving period, and
wherein during the third driving period, the first scan transistor is turned on as the first scan signal having a turn-on level voltage is supplied to a gate node of the first scan transistor, a first data voltage is supplied from the first data line to the first node as the first scan transistor is turned on, the first sensing transistor is turned on as the first sensing signal having a turn-on level voltage is supplied to a gate node of the first sensing transistor, and a second reference voltage is supplied from the first reference voltage line to the second node as the first sensing transistor is turned on, and
during the fourth driving period, the first scan transistor is turned off as the first scan signal having a turn-off level voltage is supplied to a gate node of the first scan transistor, the first sensing transistor is turned off as the first sensing signal having a turn-off level voltage is supplied to a gate node of the first sensing transistor, and the first node and the second node are electrically floated as the first scan transistor and the first sensing transistor are turned off.

11. The display device of claim 7, wherein the second driving period includes a fifth driving period and a sixth driving period, and
wherein during the fifth driving period, the second scan transistor is turned on as the second scan signal having a turn-on level voltage is supplied to a gate node of the second scan transistor, a second data voltage is supplied from the second data line to the sixth node as the second scan transistor is turned on, the second sensing transistor is turned on as the second sensing signal having a turn-on level voltage is supplied to a gate node of the second sensing transistor, and a second reference voltage is supplied from the second reference voltage line to the seventh node as the second sensing transistor is turned on, and
during the sixth driving period, the second scan transistor is turned off as the second scan signal having a turn-off level voltage is supplied to a gate node of the second scan transistor, the second sensing transistor is turned off as the second sensing signal having a turn-off level voltage is supplied to a gate node of the second sensing transistor, and the sixth node and the seventh node are electrically floated as the second scan transistor and the second sensing transistor are turned off.

12. A display device, comprising:
a first subpixel;
a first data line connected to the first subpixel;
a second data line connected to the first subpixel;
a first reference voltage line connected to the first subpixel;
a second reference voltage line connected to the first subpixel;
a data link line connected to receive a data voltage;
a sensing driving link line connected to receive a sensing driving voltage; and
a first selection circuit electrically connecting one of the data link line or the sensing driving link line with one of the first data line or the second data line.

13. The display device of claim 12, comprising:
a reference voltage link line to which a reference voltage is applied;
an analog-to-digital converter;
a readout line connected to the analog-to-digital converter; and
a second selection circuit electrically connecting one of the reference voltage link line or the readout line with one of the first reference voltage line or the second reference voltage line.

14. The display device of claim 12, wherein the first subpixel includes:
a light emitting element including a pixel electrode, an intermediate layer, and a common electrode;
a first driving transistor connected between a second node and a third node and configured to switch based on a voltage applied to a first node to drive the light emitting element;
a first scan transistor connected between a first data line among the plurality of data lines and the first node and configured to switch based on a first scan signal;
a first sensing transistor connected between a first reference voltage line among the plurality of reference voltage lines and the second node and configured to switch based on a first sensing signal;
a first emission control transistor connected between the first node and a fourth node and configured to switch based on a first emission control signal;
a second emission control transistor connected between the second node and a fifth node and configured to switch based on the first emission control signal; and
a storage capacitor electrically connected between the fourth node and the fifth node, and
wherein a first gate node of the first emission control transistor and a second gate node of the second emission control transistor are connected.

15. The display device of claim 12, wherein the first subpixel includes:
a light emitting element including a pixel electrode, a light emitting layer, and a common electrode;
a first driving transistor connected between the first driving voltage line and the pixel electrode and configured to switch based on a first gate voltage; and
a second driving transistor connected between the second driving voltage line and the pixel electrode and configured to switch based on a second gate voltage different from the first gate voltage.

16. A subpixel, comprising:
a light emitting element including a pixel electrode, a light emitting layer, and a common electrode;
a first driving transistor connected between the first driving voltage line and the pixel electrode and configured to switch based on a first gate voltage; and
a second driving transistor connected between the second driving voltage line and the pixel electrode and configured to switch based on a second gate voltage different from the first gate voltage.

17. The subpixel of claim 16, further comprising:
a first emission control transistor connected between the first driving transistor and the pixel electrode and configured to switch based on a first emission control signal;
a second emission control transistor having a second gate node connected to a first gate node of the first emission control transistor and configured to be turned on or off based on the first emission control signal;
a third emission control transistor connected between the second driving transistor and the pixel electrode and configured to be turned on or off based on a second emission control signal; and
a fourth emission control transistor having a fourth gate node connected to a third gate node of the third emission control transistor and configured to be turned on or off based on the second emission control signal.

18. The subpixel of claim 17,
wherein during a first driving period, a first data voltage is applied to a fifth gate node from a first data line electrically connected to the fifth gate node of the first driving transistor, and a second sensing driving voltage is applied to a sixth gate node from a second data line electrically connected to the sixth gate node of the second driving transistor, and
during a second driving period, a first sensing driving voltage is applied to the fifth gate node from the first data line, and a second data voltage is applied to the sixth gate node from the second data line.
